(19) United States
(12) Patent Application Publication
(10) Pub. No.: US 2021/0146549 A1
(43) Pub. Date: May 20, 2021

(54) GRIPPING DEVICE AND GRIPPING METHOD

(71) Applicant: INDUSTRIAL TECHNOLOGY RESEARCH INSTITUTE, Hsinchu (TW)

(72) Inventors: Ping-Chang SHIH, Yuanlin City (TW); Dong-Chen TSAI, Miaoli City (TW)

(73) Assignee: INDUSTRIAL TECHNOLOGY RESEARCH INSTITUTE, Hsinchu (TW)

(21) Appl. No.: 16/728,979

(22) Filed: Dec. 27, 2019

(30) Foreign Application Priority Data
Nov. 19, 2019 (TW) 108141916

(51) Int. Cl. B25J 9/16; H04N 5/225; G05B 13/02

(52) U.S. Cl. CPC B25J 9/1697; G05B 13/0265; H04N 5/2253

(57) ABSTRACT

A gripping device and a gripping method are provided. The gripping device includes a gripping component and an imaging element. The imaging element is configured to obtain an imaged result of an object. An action of the gripping component is generated through a training model according to the imaged result and at least one parameter. The gripping component grasps the object according to the action. A first parameter and a third parameter of the at least one parameter refer to the same axis, and a second parameter and the first parameter of the at least one parameter refer to distinct axes.

This application claims the benefit of Taiwan application Serial No. 108141916, filed Nov. 19, 2019, the disclosure of which is incorporated by reference herein in its entirety.

### TECHNICAL FIELD

The disclosure relates in general to a gripping device and a gripping method.

### BACKGROUND

The technology of grasping an object using a robotic arm is an essential tool towards automated manufacturing. Along with the development in artificial intelligence (AI), the industries are dedicated to the robotic arm whose learning is based on artificial intelligence to grasp a random object.

The use of the robotic arm based on artificial intelligence (reinforcement learning) for grasping a random object is normally limited to the scenario where the robotic arm could only grasp the object from the top of the object in the vertical direction. However, such grasping method is often unable to successfully grasp the object when the object has a complicated shape.

### SUMMARY

The disclosure relates to a gripping device and a gripping method capable of resolving the above problems.

According to one embodiment, a gripping device is provided. The gripping device includes an actuating device and an imaging element. The actuating device includes a gripping component. The imaging element is configured to obtain an imaged result of an object. An action of the gripping component is generated through a training model according to the imaged result and at least one parameter. The gripping component grasps the object according to the action. A first parameter and a third parameter of the at least one parameter refer to the same axis, and a second parameter and the first parameter of the at least one parameter refer to distinct axes.

According to another embodiment, a gripping device is provided. The gripping device includes a gripping component and an imaging element. The imaging element is configured to obtain an imaged result of an object. An action of the gripping component is generated through a training model according to the imaged result and at least one parameter. The gripping component grasps the object according to the action, and grasping an object during the training process of the training model is a uniform trial-and-error. A first parameter and a third parameter of the at least one parameter refer to the same axis, and a second parameter and the first parameter of the at least one parameter refer to distinct axes.

According to an alternate embodiment of the disclosure, a gripping method is provided. The gripping method includes the following steps: obtaining an imaged result of an object by an imaging element; generating an action of the gripping component through a training model according to the imaged result and at least one parameter; and grasping the object by the gripping component according to the action. A first parameter and a third parameter of the at least one parameter refer to the same axis, and a second parameter and the first parameter of the at least one parameter refer to distinct axes.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 is a block diagram of a gripping device according to an embodiment of the disclosure.

FIG. 2 is a scenario diagram of a gripping device grasping an object according to an embodiment of the disclosure.

FIG. 3 is a flowchart of a gripping method according to an embodiment of the disclosure.

FIG. 4 is a flow chart of the construction process of a training model according to an embodiment of the disclosure.

FIG. 5 is a comparison diagram between the success rate and the number of times of trial-and-error for grasping an object using the gripping method according to an embodiment of the disclosure and that using other method.

FIG. 6 is a comparison diagram between the success rate and the number of times of trial-and-error for grasping another object using the gripping method according to an embodiment of the disclosure and that using other method.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The disclosure provides a gripping device and a gripping method. Even when the shape of an object is unknown, the gripping device and the gripping method of the disclosure based on self-learning may still find an orientation in which the object may be successfully grasped by a gripping component.

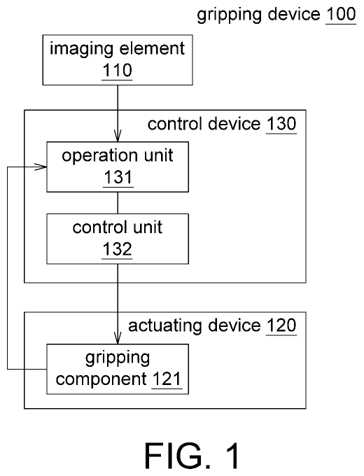

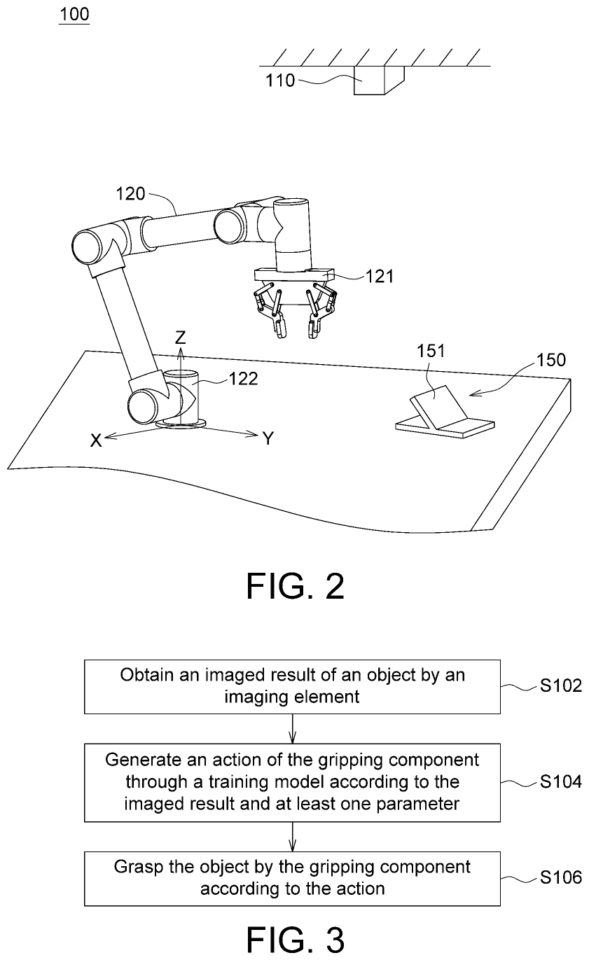

FIG. 1 is a block diagram of a gripping device 100 according to an embodiment of the disclosure. FIG. 2 is a scenario diagram of a gripping device 100 grasping an object 150 according to an embodiment of the disclosure.

Refer to FIG. 1 and FIG. 2. The gripping device 100 includes an imaging element 110 and an actuating device 120. The actuating device 120 may be realized by a robotic arm, which grasps an object 150 by using a gripping component 121 such as an end effector. Furthermore, the gripping device 100 further includes a control device 130, which controls the actuating device 120 to perform an action. The imaging element 110, such as a camera, a video recorder or a monitor, may be disposed above the gripping component 121 to obtain an imaged result of the object 150. Specifically, the imaging range of the imaging element 110 at least covers the object 150, such that relevant information regarding the appearance of the object 150 may be obtained.

The control device 130 includes an operation unit 131 and a control unit 132. The imaging element 110 is coupled to the operation unit 131 for inputting the imaged result to the operation unit 131. The operation unit 131 is coupled to the control unit 132. The control unit 132 is coupled to the actuating device 120 for controlling the gripping component 121.

The operation unit 131 may construct a training model (neural network model) based on self-learning. For example, the operation unit 131 may gradually construct a training model by using the neural network algorithm during the process when the gripping component 121 continuously attempts to grasp the object 150. The neural network algorithm may include but is not limited to deep deterministic policy gradient (DDPG) algorithm, deep Q-learning network (DQN) algorithm, and asynchronous advantage actor-critic (A3C) algorithm. During the training process of the training model, the gripping component 121 performs the trial-and-error procedure for several times to find an action by which the gripping component 121 may successfully grasp the object 150.

To put it in greater details, during each time of performing the trial-and-error procedure, the control unit 132 causes the gripping component 121 to move and change its posture, such that the gripping component 121 may perform the action and move to a fixed point and change the posture to a specified “orientation”, and attempt to grasp the object 150 at the specified position and orientation. The operation unit 131 further evaluates and marks the performance of each grasping behavior and updates a learning experience according to the marks scored during the trial-and-error procedures. Thus, the action by which the gripping component 121 successfully grasps the object 150 may be found, and the training model may be constructed.

Referring to FIG. 3, a flowchart of a gripping method according to an embodiment of the disclosure is shown. Firstly, the process begins at step S102, an imaged result of object 150 is obtained by the imaging element 110. For example, the imaged result may include but is not limited to relevant information regarding the appearance of the object 150. The object 150 may be an object with different appearances. In an embodiment, the imaged result may include a color image and a depth image.

Then, the process proceeds to step S104, an action of the gripping component 121 is generated through the training model according to the imaged result and at least one parameter, wherein the action of the gripping component 121 may be determined according to at least one parameter. The operation unit 131 may generate a set of values through a training model based on learning experience according to the imaged result. The control unit 132 may substitute the set of values generated through the training model to at least one parameter to generate the action of the gripping component 121 for causing the gripping component 121 to move to a fixed point and change its posture to a specified orientation.

Then, the process proceeds to step S106, the object 150 is grasped by the gripping component 121 according to the action, wherein the control unit 132 causes the gripping component 121 to reflect the action and grasp the object 150 according to the fixed point and the specified orientation disclosed above.

Details of the construction process of the training model are disclosed below.

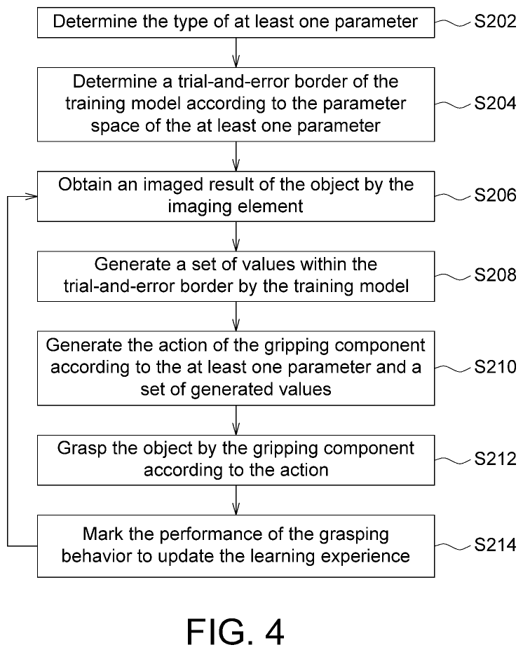

Referring to FIG. 4, a flow chart of the construction process of a training model according to an embodiment of the disclosure is shown. The construction process of the training model disclosed below may be performed in a simulated environment or an actual environment.

Firstly, the process begins at step S202, the type of the at least one parameter is determined, wherein the at least one parameter is used for defining an action performed by the gripping component 121 under the command of the control unit 132. For example, the at least one parameter may be an angle or an angular vector, and the action may be relevant to rotation. In an embodiment, the action may include a 3D rotation sequence, and the integrated 3D rotation effect (Q) of the action may be represented by formula (1):

Q=R_{Z}(ϕ)R_{X}(ω)R_{Z}(δ) (1)

Wherein, Q may be formed of three 3×3 rotation matrixes, which include a first parameter δ, a second parameter ω and a third parameter ϕ. The first parameter δ, the second parameter ω, the third parameter ϕ and the action form a linear transformation relationship. The three rotation matrixes are as follows:

$${R}_{Z} ( δ ) = [ \begin{matrix}cos δ & - sin δ & 0 \\ sin δ & cos δ & 0 \\ 0 & 0 & 1\end{matrix} ] , {R}_{{ }_{X}} ( ω ) = [ \begin{matrix}1 & 0 & 0 \\ 0 & cos ω & - sin ω \\ 0 & sin ω & cos ω\end{matrix} ] , and$$

$${R}_{Z} ( φ ) = [ \begin{matrix}cos φ & - sin φ & 0 \\ sin φ & cos φ & 0 \\ 0 & 0 & 1\end{matrix} ] .$$

Moreover, the first parameter and the third parameter ϕ refer to the same axis, such as the Z-axis, and the second parameter ω refers to the X-axis. That is, the first parameter δ and the third parameter ϕ refer to the same axis, and the second parameter ω and the first parameter δ refer to distinct axes. However, the above parameters may also be represented by another set of axes.

Refer to FIG. 2. The original point of the reference coordinate system is located at the base 122 of the actuating device 120, that is, at the junction between the actuating device 120 and the setting surface. For example, when the gripping component 121 performs the action, the gripping component 121 firstly rotates δ units with respect to the Z-axis of the reference coordinate system, then rotates ω units with respect to X-axis, and lastly rotates ϕ units with respect to the Z-axis to form a 3D rotation sequence. Particularly, the 3D rotation sequence may satisfy the definition of the proper Euler angles.

Refer to FIG. 4. In step S204, a trial-and-error border of the training model is determined according to the parameter space of the at least one parameter. The physical meaning of parameter space may determine the trial-and-error border of the training model. For example, the physical meaning of the first parameter δ, the second parameter ω and the third parameter ϕ are relevant to the angle or the angular vector and the first parameter δ, the second parameter ω and the third parameter ϕ. The first parameter δ, the second parameter ω and the third parameter ϕ respectively have an independent parameter space, such as a first parameter space, a second parameter space and a third parameter space. The parameter spaces are relevant to the angle or the angular vector and may determine a trial-and-error border of the training model.

As indicated in FIG. 2, via the trial-and-error border of the training model, in each subsequent trial-and-error procedure, the position of the gripping component 121 would be determined to move the object 150 or the orientation of the gripping component 121 would be determined to grasp the object 150.

Refer to FIG. 4. Then, the trial-and-error procedure is performed for a number of times. As indicated in FIG. 4, in each trial-and-error procedure, steps S206, S208, S210, S212 and S214 are performed respectively, such that the training model based on learning experience will continuously update in each trial-and-error procedure to achieve self-learning.

In step S206, an imaged result of the object 150 is obtained by the imaging element 110.

In step S208, a set of values is generated within the trial-and-error border by the training model, wherein during each time of performing the trial-and-error procedure, the operation unit 131 may generate a set of values within the trial-and-error border through the training model based on learning experience according to the imaged result of the imaging element 110. Moreover, during several times of performing the trial-and-error procedure, the training model may perform a uniform trial-and-error within the trial-and-error border.

To put it in greater details, if the first parameter space of the first parameter δ, the second parameter space of the second parameter ω and the third parameter space of the third parameter ϕ are mutually independent, then the range of the first parameter space, the second parameter space and the third parameter space corresponds to a trial-and-error border of the training model. During each time of performing the trial-and-error procedure, the training model respectively generates a first value in the first parameter space, a second value in the second parameter space, and a third value in the third parameter space in the form of an uniform probability distribution to generate a set of values formed of the first value, the second value and the third value. In this way, during several times of performing the trial-and-error procedure, the first value, the second value and the third value may be uniformly selected in the first parameter space, the second parameter space, and the third parameter space, respectively. Thus, the training model within the trial-and-error border may perform a uniform trial-and-error procedure.

Suppose in step S204, the first parameter space of the first parameter δ, the second parameter space of the second parameter ω and the third parameter space of the third parameter are in a range of [0, π]. Then, during each time of performing the trial-and-error procedure, the training model selects a value from the range of [0, π/2] according to the uniform probability distribution and uses the selected value as the value of the first parameter δ, selects a value the range of [0, π/2] from according to the uniform probability distribution and uses the selected value as the value of the second parameter ω, and selects a value from the range of [0, π] according to the uniform probability distribution and uses the selected value as the value of the third parameter ϕ. An embodiment in which the training model within the trial-and-error border performs the uniform trial-and-error procedure is exemplified in the following list:

| Trial-and-error | First | Second | Third |
|---|---|---|---|
| procedure | parameter | parameter | parameter |
| (times) | δ | ω | ϕ |
| 1 | A1 | B1 | C1 |
| 2 | A2 | B2 | C2 |
| 3 | A3 | B3 | C3 |
| . | . | . | . |
| . | . | . | . |
| . | . | . | . |
| n | An | Bn | Cn |

Wherein, n represents the number of times for which the trial-and-error procedure is performed; A1-An are generated according to the uniform probability distribution; B1-Bn are generated according to the uniform probability distribution; C1-Cn are generated according to the uniform probability distribution. During the n-th time of performing the trial-and-error procedure, the training model generates a set of values An, Bn, and Cn within the trial-and-error border according to the above arrangement.

Then, the process proceeds to step S210, the action of the gripping component 212 is generated by the control unit 132 according to the at least one parameter and a set of generated values. For example, during the n-th time of performing the trial-and-error procedure, the control unit 132 substitutes the values An, Bn, and Cn generated by the training model to the first parameter δ, the second parameter ω and the third parameter ϕ of formula (1) to generate an action of the gripping component 121 for causing the gripping component 121 to move to a position and change to a specified orientation. The gripping component 121 firstly rotates by an angle An with respect to the of the reference coordinate system Z-axis, then rotates by an angle Bn with respect to X-axis, and lastly rotates by an angle Cn with respect to Z-axis to achieve the specified orientation.

Then, the process proceeds to step S212, the object 150 is grasped by the gripping component 121 according to the action. The control unit 132 causes the gripping component 121 to move to the specified orientation to grasp the object 150. Besides, during several times of performing the trial-and-error procedure, that the gripping component 121 grasps the object 150 according to the action is a uniform trial-and-error. That is, during the training process of the training model, the gripping component 121 attempts to grasp the object 150 uniformly at each orientation in the 3D space.

For example, when the action of the gripping component 121 includes a 3D rotation sequence satisfying the definition of proper Euler angles, the gripping component 121 uniformly performs trial-and-error during several times of performing the trial-and-error procedure and gradually constructs the training model through which the gripping device 100 may independently grasp the object 150.

Refer to FIG. 4. In step S214, the performance of the grasping behavior of step S212 is marked by the training model to update the learning experience. If the trial-and-error procedure has not yet been performed for the predetermined number of times (the number of times of trial-and-error predetermined by the user has not been reached), then the position and/or the posture of the object 150 is changed at random, and the process returns to step S206 to perform the trial-and-error procedure again until the trial-and-error procedure is performed for the predetermined number of times. After the trial-and-error procedure has been performed for the predetermined number of times, if the constructed training model has a success rate of grasping higher than a threshold, this implies that the expected learning target is achieved, and the constructed training model may be adapted to the gripping device for grasping the object. After the trial-and-error procedure has been performed for the predetermined number of times, if the constructed training model has a success rate of grasping lower than a threshold, the user resets the trial-and-error procedure for the self-learning algorithm.

In short, during each time of performing the trial-and-error procedure, the training model will update the learning experience and adjust the strategy according to the imaged result obtained by the imaging element 110 (such as the information relevant to the appearance of the photographed object 150) and the performance of the grasping behavior corresponding to the imaged result, such that the gripping component 121 may successfully grasp the object 150 next time when the trial-and-error procedure is performed.

It should be particularly noted that according to the gripping method disclosed above, the gripping component may grasp the object at a position deviated from object the plumb direction. As indicated in FIG. 2, when the action of the gripping component 121 is generated through the training model according to the training method of the disclosure which is based on self-learning, the gripping component 121 moves to a fixed point and reaches a specified orientation, which is deviated from the plumb direction of the object 150 (the plumb direction is right above the object 150 and parallel to the Z-axis). In other words, according to the training method of the disclosure which is based on self-learning, the direction of the force applied to the object by the gripping component is not limited to the direction right above the object, such that the gripping component may successfully grasp the object with a complicated appearance. Through the training model, the gripping component of the disclosure may grasp the object having different appearances according to the training method based on self-learning.

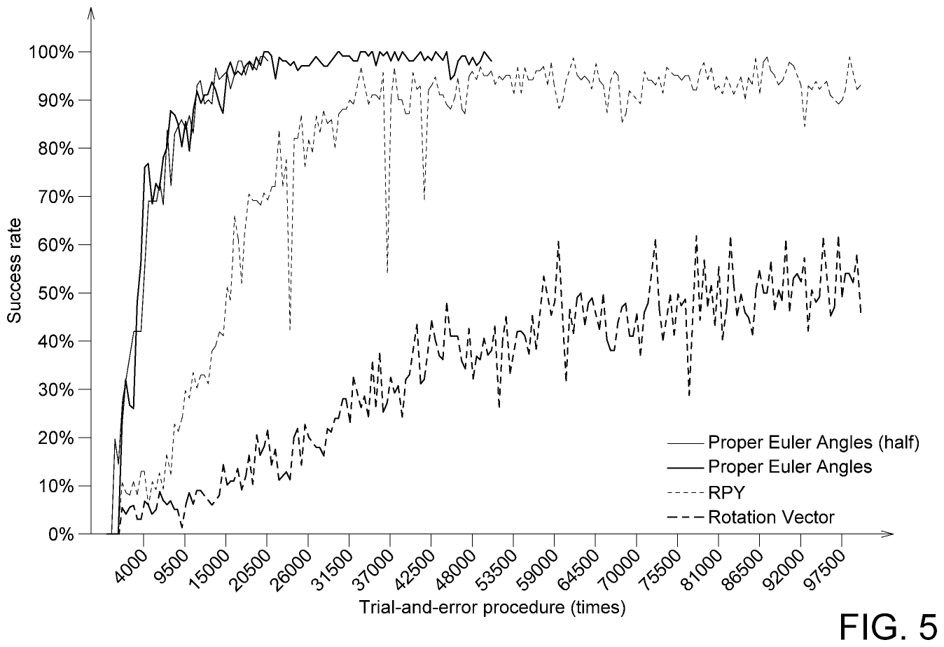

Referring to FIG. 5, a comparison diagram between the success rate and the number of times of trial-and-error for grasping an object 150 using the gripping method according to an embodiment of the disclosure and that using other method is shown. In the present embodiment, the object 150 featured by an inclined plate 151 as indicated in FIG. 2 is used as a target. When the action of the gripping component 121 includes different 3D rotations, the grasping performance will have significant difference.

As indicated in FIG. 5, when the action includes the 3D rotation sequence satisfying the definition of proper Euler angles, the 3D rotation effect curve fitted using the gripping method of the disclosure soars up rapidly, and the success rate is approximate to 100% when the trial-and-error procedure is performed for only a half of the predetermined number of times (for example, near 20,000 times). On the contrary, the 3D rotation effect curve fitted using other gripping method increases slowly, and the success rate is stably below 100%.

The gripping method of the disclosure may grasp not only the object 150 featured by the inclined plate 151, but also the object with various appearances, such as the object featured by a curved surface, a spherical surface, an angle or a combination thereof.

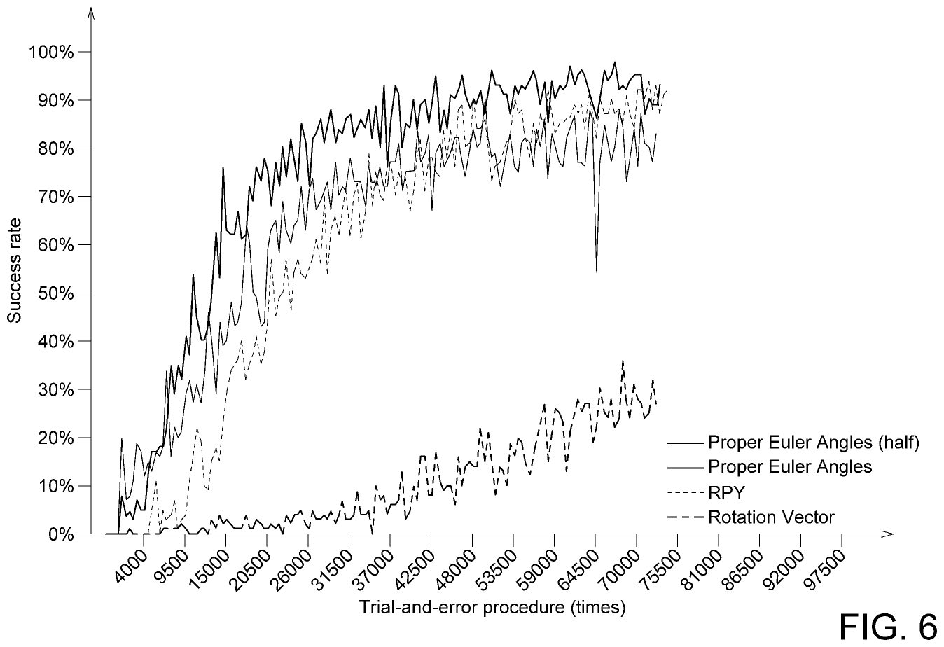

Referring to FIG. 6, a comparison diagram between the success rate and the number of times of trial-and-error for grasping another object 150 using the gripping method according to an embodiment of the disclosure and that using other method is shown. In the present embodiment, the object may be a cuboid structure. As indicated in the diagram, under the circumstances that the object has a simple appearance, the learning performance obtained from the action of the gripping component including a 3D rotation sequence satisfying the definition of proper Euler angles is still superior to that obtained from the action of the gripping component including other 3D rotations.

Thus, the 3D rotation sequence represented by the proper Euler angles has excellent compatibility with the training model based on self-learning, and may work together to improve the learning effect. Besides, the training method of the disclosure based on self-learning does not require its operator to have the image processing background or program a proper grasping path and is adapted to the gripping component for grasping the object with various appearance.

It will be apparent to those skilled in the art that various modifications and variations may be made to the disclosed embodiments. It is intended that the specification and examples be considered as exemplary only, with a true scope of the disclosure being indicated by the following claims and their equivalents.

What is claimed is:

1. A gripping device comprising:
an imaging element configured to obtain an imaged result of an object; and
an actuating device comprising a gripping component, wherein an action of the gripping component is generated through a training model according to the imaged result and at least one parameter, and the gripping component grasps the object according to the action;
wherein a first parameter and a third parameter of the at least one parameter refer to the same axis, and a second parameter and the first parameter of the at least one parameter refer to distinct axes.

2. The gripping device according to claim 1, wherein the imaging element is disposed above the gripping component.

3. The gripping device according to claim 1, wherein the first parameter, the second parameter, the third parameter and the action form a linear transformation relationship.

4. The gripping device according to claim 1, wherein the at least one parameter is an angle or an angular vector.

5. The gripping device according to claim 1, wherein the action comprises a 3D rotation sequence.

6. The gripping device according to claim 5, wherein the 3D rotation sequence satisfies the definition of proper Euler angles.

7. The gripping device according to claim 1, wherein a training method of the training model is based on self-learning.

8. The gripping device according to claim 7, wherein the gripping component is capable of grasping the object with various appearances according to the action generated through the training model trained by the training method based on self-learning.

9. The gripping device according to claim 7, wherein the action generated through the training model trained by the training method based on self-learning causes the gripping component to move to a fixed point and reach a specified orientation, which is deviated from the plumb direction of the object.

10. The gripping device according to claim 1, wherein each of the first parameter, the second parameter and the third parameter has an independent parameter space.

11. The gripping device according to claim 10, wherein the parameter spaces determine a trial-and-error border of the training model.

12. The gripping device according to claim 11, wherein during the training process, the training model executes a uniform trial-and-error within the trial-and-error border.

13. The gripping device according to claim 12, wherein the gripping component grasps the object according to the uniform trial-and-error.

14. A gripping device comprising:
an imaging element configured to obtain an imaged result of an object; and
a gripping component, wherein an action of the gripping component is generated through a training model according to the imaged result and at least one parameter, the gripping component grasps the object according to the action, and grasping the object during the training process of the training model is a uniform trial-and-error;
wherein a first parameter and a third parameter of the at least one parameter refer to the same axis, and a second parameter and the first parameter of the at least one parameter refer to distinct axes.

15. The gripping device according to claim 14, wherein the action comprising a 3D rotation sequence.

16. The gripping device according to claim 15, wherein the 3D rotation sequence satisfies the definition of proper Euler angles.

17. A gripping method comprising:
obtaining an imaged result of an object by an imaging element;
generating an action of the gripping component through a training model according to the imaged result and at least one parameter; and
grasping the object by the gripping component according to the action;
wherein a first parameter and a third parameter of the at least one parameter refer to the same axis, and a second parameter and the first parameter of the at least one parameter refer to distinct axes.

18. The gripping method according to claim 17, wherein the first parameter, the second parameter, the third parameter and the action form a linear transformation relationship.

19. The gripping method according to claim 17, wherein the action comprises a 3D rotation sequence.

20. The gripping method according to claim 19, wherein the 3D rotation sequence satisfies the definition of proper Euler angles.

21. The gripping method according to claim 17, wherein a training method of the training model is based on self-learning.

22. The gripping method according to claim 21, wherein the gripping component is capable of grasping the object with various appearances according to the action generated through the training model trained by the training method based on self-learning.

23. The gripping method according to claim 21, wherein the action generated through the training model trained by the training method based on self-learning causes the gripping component to move to a fixed point and reach a specified orientation, which is deviated from the plumb direction of the object.

24. The gripping method according to claim 17, wherein each of the first parameter, the second parameter and the third parameter has an independent parameter space.

25. The gripping method according to claim 24, wherein the parameter spaces determine a trial-and-error border of the training model.

26. The gripping method according to claim 25, further comprising:
executing a uniform trial-and-error within the trial-and-error border by the training model during the training process of the training model.

27. The gripping method according to claim 26, wherein the gripping component grasps the object according to the uniform trial-and-error.
